(19) United States
(12) Patent Application Publication
(10) Pub. No.: US 2012/0009961 A1
(43) Pub. Date: Jan. 12, 2012

(54) METHOD AND APPARATUS FOR BEAMFORMING IN A WIRELESS COMMUNICATION SYSTEM

(75) Inventors: Kiran ULN, Pleasanton, CA (US); Thomas E. PARE, JR., Mountain View, CA (US); Gary ANWYL, Palo Alto, CA (US); Yung-Szu TU, Jhubei City (TW); Chun-Hsien WEN, Zhongli City (TW); Lihua WENG, Jhubei City (TW); Henry LIN, Jhubei City (TW)

(73) Assignee: Ralink Technology (Singapore) Corporation PTE. LTD., Singapore (SG)

(21) Appl. No.: 12/832,887

(22) Filed: Jul. 8, 2010

(51) Int. Cl. H04W 52/04; H04W 72/04

(52) U.S. Cl. 455/509

(57) ABSTRACT

Varying embodiments of the present invention describes a method and apparatus for beamforming in a wireless communication system. A first embodiment is a method for beamforming in a wireless communication system, the system comprising a transmitter and a receiver. The method comprises initiating beamforming on a communication channel between the transmitter and the receiver wherein the communication channel comprises at least two transmit chains, controlling the beamforming by mapping the data stream(s) to the at least two transmit chains and controlling the scaling of the at least two transmit chains within a transmit power constraint.

### FIELD OF THE INVENTION

The present invention relates generally to wireless communication systems and more specifically to beamforming in a wireless communication system.

### BACKGROUND

Beamforming is a method for using wireless channel information to transmit signals to the receiver in order to improve reception quality, and increase data throughput in a Multi-In, Multi-Out (MIMO) communication system. This requires that the channel information is available at the transmitter. This information can be learned in a single sided fashion at the transmitter (relying on the channel reciprocity) or with a closed loop communication of the channel sounding packets processed at the receiver and the beamforming information be retransmitted back to the transmitter. In general, the beamforming parameters are very straightforward to compute for a given channel condition. However, the wireless channel between the transmitter and receiver is constantly changing, due to changes in the environment, which cause fluctuation in the Signal-to-Noise Ration (SNR) and varying multipath conditions.

Under the constraint of equal modulation, the receiver can tolerate some disparity in the SNRs. However, there is a limit beyond which extra SNR on the high SNR stream(s) is not effective and the performance is limited by the low SNR stream(s). This disparity only increases with the dimension of the MIMO channel. Accordingly, what is desired is to provide a system and method that overcomes the above issues. The present invention addresses such a need.

### SUMMARY OF THE INVENTION

Varying embodiments of the present invention describes a method and apparatus for beamforming in a wireless communication system. The invention employs variations in scaling characteristics to improve beamforming. Specifically, by selectively utilizing certain scaling parameters, power can be redistributed from the low SNR stream to the high SNR stream. The advantage is that the link stability is improved, and high throughput with active beamforming is maintained.

A first embodiment is a method for beamforming in a wireless communication system, the system comprising a transmitter and a receiver. The method comprises initiating beamforming on a communication channel between the transmitter and the receiver wherein the communication channel comprises at least two transmit chains, controlling the beamforming by mapping the data stream(s) to the at least two transmit chains and controlling the scaling of the at least two transmit chains within a transmit power constraint.

A second embodiment is a wireless communication system comprising a transmitter, a receiver, a communication channel for communication therebetween wherein the transmitter and receiver each include a mechanism capable of performing the following steps: initiating beamforming on the communication channel between the transmitter and the receiver wherein the communication channel comprises at least two transmit chains, controlling the beamforming by mapping the data stream(s) to the at least two chains and controlling the scaling of the at least two transmit chains within a transmit power constraint.

Other aspects and advantages of the present invention will become apparent from the following detailed description, taken in conjunction with the accompanying drawings, illustrating by way of example the principles of the invention.

### BRIEF DESCRIPTION OF DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 shows a flowchart of a method in accordance with an embodiment of the present invention.

FIG. 2 shows a system in accordance with an embodiment of the present invention.

### DETAILED DESCRIPTION OF PREFERRED EMBODIMENTS

The present disclosure relates to a method and system for closed loop beamforming for MIMO OFDM wireless communication systems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Varying embodiments of the present invention describes a method and apparatus for beamforming in a wireless communication system. The invention employs variations in scaling characteristics to improve beamforming. Specifically, by selectively utilizing certain scaling parameters, power can be redistributed from the low SNR stream to the high SNR stream. The advantage is that the link stability is improved, and high throughput with active beamforming is maintained.

The system in accordance with the present invention can take the form of an entirely hardware implementation, an entirely software implementation, or an implementation containing both hardware and software elements. In one implementation, this detection procedure is implemented in software, which includes, but is not limited to, application software, firmware, resident software, microcode, etc.

Furthermore, the method can be implemented in the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present invention in more detail, refer now to the following description in conjunction with the accompanying Figures.

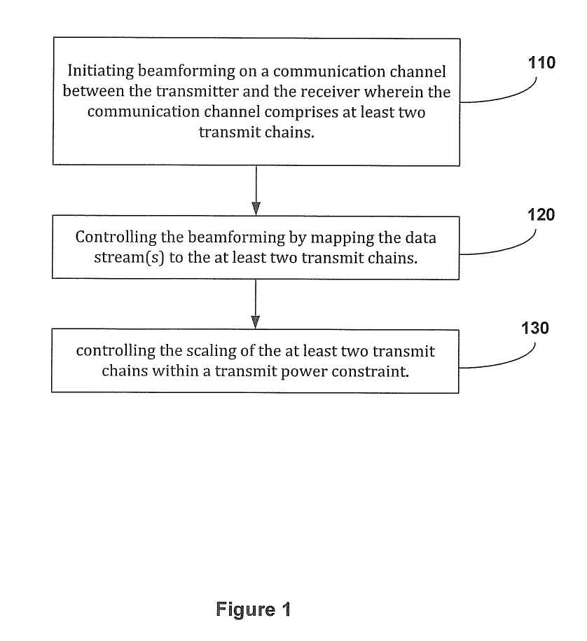

FIG. 1 shows a flowchart of a method in accordance with an embodiment of the present invention. Step 110 involves initiating beamforming on a communication channel between the transmitter and the receiver wherein the communication channel comprises at least two transmit chains. A second step 120 involves controlling the beamforming by mapping the data stream(s) to the at least two transmit chains. A final step 130 involves controlling the scaling of the at least two transmit chains within a transmit power constraint. Each transmit chain may have a power constraint as imposed by the power amplifiers. There may also be regulatory requirements on the power and spectrum on each transmit chain and overall system.

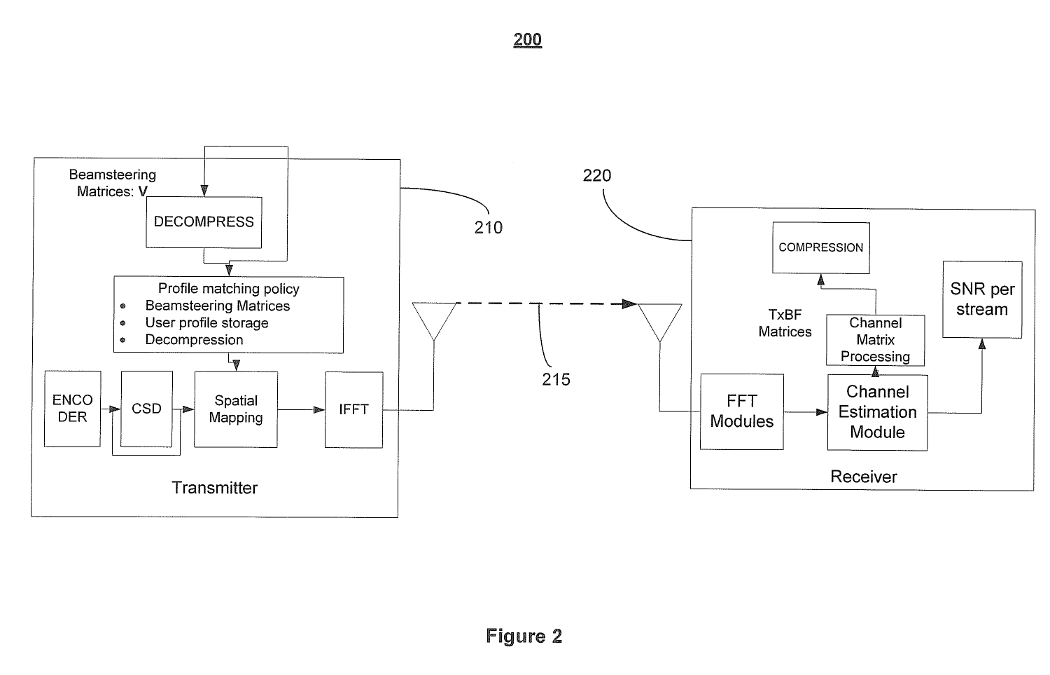

FIG. 2 shows a system 200 in accordance with an embodiment of the present invention. The system 200 includes a transmitter 210 and a receiver 220 capable of communicated via a communication channel 215. When transmitting multiple streams to the receiver 220, the streams will interfere with each other. However, as previously mentioned, beamforming utilizes wireless channel information to transmit signals to the receiver in order to improve reception quality, and increase data throughput.

During operation, the communication channel 215 can have a wide spread of singular values whereby the SNRs seen by the different streams is proportional to these singular values. In any case, there will be high SNR stream(s) and low SNR stream(s). Most systems employ equal modulation techniques to minimize complexity. However, under the constraint of equal modulation, the receiver 215 can tolerate limited disparity in the SNRs. Specifically, there is a limit beyond which extra SNR on high SNR stream (s) is ineffective and the performance is limited by the low SNR stream(s). This disparity only increases with the dimensions of the MIMO channel and the number of data streams being transmitted.

In order to minimize the effects of this disparity, the data streams being transmitted over the communication channel 215 are controlled by employing a scaling matrix to keep the data streams within a predetermined transmit power constraint. By suitable choosing the scaling matrix, power can be effectively re-distributed from the low SNR stream to the high SNR stream. Additionally, if the scaling matrix is a diagonal, the data streams will remain independent. An OFDM system which employs beamforming over multiple tones will typically have the beamforming matrices spanning the entire dimension uniformly and randomly. Therefore, with the scaling matrices being good mixing matrices, then the transmit power per chain (contributed by all the OFDM tones) is unaffected.

In an alternate embodiment, eigen scaling is employed to maximize the transmit power on each transmit chain. Here, the beamforming matrix will try to align the data streams such that the receiver obtains maximum energy from the channel. These directions are decided by the eigen vectors of the channel. Scaling these eigen vectors relative to one another (Eigen scaling) provides about 3 dB gain in MCS14 and 1.5 dB gain in MCS12. It should be noted that ±3 dB is a practical limitation of change in hardware logic and bit-widths.

Additionally, beamforming will introduce spectral shaping to the transmit chains whereby each transmit chain might not be operating at full power. For example, in a 3×1 system, the only useful parameter is the phase of the V matrix. However, impairments might result in some entry of V averaging to less than ⅓ over all of the sub carriers. In order to combat this, transmit power on each transmit x_{bf} is scaled to maximize the transmit power on each transmit chain based on the following relationship:

x_{Tx}=PVΛx

Here P is a M×M diagonal matrix configured to maximize the transmit power per chain.

Varying embodiments of the present invention describes a method and apparatus for beamforming in a wireless communication system. The invention employs variations in scaling characteristics to improve beamforming. Specifically, by selectively utilizing certain scaling parameters, power can be redistributed from the low SNR stream to the high SNR stream. The advantage is that the link stability is improved, and high throughput with active beamforming is maintained.

Without further analysis, the foregoing so fully reveals the intent of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although these inventive concepts have been described in terms of certain embodiments, other embodiments that are apparent to those of ordinary skill in the art are also within the scope of this invention, as defined in the claims that follow.

What is claimed is:

1. A method for beamforming in a wireless communication system, the system comprising a transmitter and a receiver, the method comprising:
initiating beamforming on a communication channel between the transmitter and the receiver wherein the communication channel comprises at least two transmit chains;
controlling the beamforming by mapping the data stream(s) to the at least two transmit chains; and
controlling the scaling of the at least two transmit chains within a transmit power constraint.

2. The method of claim 1 wherein mapping of the data stream(s) to the at least two transmit chains further comprises:
eigen scaling of at least two data streams mapped to the at least two chains

3. The method of claim 2 where one of the at least two streams is a stronger (for example, high signal-to-noise ratio (SNR)) stream and the other of the at least two streams is a weaker (for example, low SNR) stream and eigen scaling the at least two streams comprises:
re-distributing some power from the stronger stream(s) to the weaker stream(s).

4. The method of claim 2 wherein eigen scaling comprises:
scaling the at data streams with a scaling matrix.

5. The method of claim 4 wherein the scaling matrix is a diagonal.

6. The method of claim 1 wherein transmit power is maximized within the transmit power constraint.

7. A wireless communication system comprising:
a transmitter;
a receiver;
a communication channel for communication therebetween wherein the transmitter and receiver each include a mechanism capable of performing the following steps:
initiating beamforming on the communication channel between the transmitter and the receiver wherein the communication channel comprises at least two transmit chains; and
controlling the beamforming by mapping the data stream(s) to the at least two transmit chains;
controlling the scaling of the at least two transmit chains within a transmit power constraint.

8. The system of claim 7 wherein mapping of the data stream(s) to the at least two transmit chains further comprises:
eigen scaling of the data streams mapped to the at least two chains

9. The system of claim 8 where one of the at least two streams is a stronger (for example, high signal-to-noise ratio (SNR)) stream and the other of the at least two streams is a weaker (for example, low SNR) stream and eigen scaling the at least two streams comprises:
re-distributing some power from the stronger stream(s) to the weaker stream(s).

10. The system of claim 8 wherein eigen scaling comprises:
scaling the data streams with a scaling matrix.

11. The system of claim 10 wherein the scaling matrix is a diagonal.

12. The system of claim 7 wherein transmit power is maximized within the transmit power constraint.

13. A computer program product tangibly embodied on a computer usable medium for performing a method of beamforming in a wireless communication system, the system comprising a transmitter and a receiver, the computer program product having computer readable program means for causing a computer to perform the acts of:
initiating beamforming on a communication channel between the transmitter and the receiver wherein the communication channel comprises at least two transmit chains;
controlling the beamforming by mapping the data stream(s) to the at least two transmit chains; and
controlling the scaling of the at least two transmit chains within a transmit power constraint.

14. The computer program product of claim 13 wherein mapping of the data stream(s) to the at least two transmit chains further comprises:
eigen scaling the data streams mapped to the at least two chains

15. The computer program product of claim 14 where one of the at least two streams is a stronger (for example, high signal-to-noise ratio (SNR)) stream and the other of the at least two streams is a weaker (for example, low SNR) stream and eigen scaling the at least two streams comprises:
re-distributing some power from the stronger stream(s) to the weaker stream(s).

16. The computer program product of claim 14 wherein eigen scaling comprises:
scaling the data streams with a scaling matrix.

17. The computer program product of claim 16 wherein the scaling matrix is a diagonal.

18. The computer program product of claim 13 wherein transmit power is maximized within the transmit power constraint.
